(19) United States
(12) Patent Application Publication
(10) Pub. No.: US 2008/0305944 A1
(43) Pub. Date: Dec. 11, 2008

(54) DIELECTRIC CERAMICS AND MANUFACTURING METHOD THEREOF, AS WELL AS MULTILAYER CERAMIC CAPACITOR

(75) Inventors: Shusaku Ueda, Gunma (JP); Kazumi Kaneda, Gunma (JP); Shinichiro Ikemi, Gunma (JP)

Correspondence Address: KNOBBE MARTENS OLSON & BEAR LLP, 2040 MAIN STREET, FOURTEENTH FLOOR, IRVINE, CA, 92614, US

(73) Assignee: Yaiyo Yuden Co., Ltd., Tokyo (JP)

(21) Appl. No.: 12/099,720

(22) Filed: Apr. 8, 2008

(30) Foreign Application Priority Data
Apr. 9, 2007 (JP) 2007-102103

(51) Int. Cl. C04B 35/468

(52) U.S. Cl. 501/137

(57) ABSTRACT

Dielectric ceramics capable of decreasing the displacement causing ringing and a multi-layer ceramic capacitor capable of decreasing occurrence of ringing in which the dielectric ceramics comprise a solid solution represented by:

Ba—Ti—Zr—Re-Me-O₃

where (Re is at least one metal element selected from La, Ce, Pr, Nd, Sm, Eu, Gd, Tb, Dy, Ho, Er, Tm, Yb, Lu and Y, Me is a metal element selected from Mg, Cr, and Mn, and Zr is an arbitrary ingredient), and SiO₂, where

Ti:Zr is from 100:0 to 75:25, and Ba is from 97 mol to 103 mol, Re is from 2 mol to 18 mol, Me is from 2 mol to 18 mol, and SiO₂ is from 0.5 mol to 10 mol assuming Ti+Zr as 100 mol.

### BACKGROUND OF THE INVENTION

1. Field of the Invention

The present invention concerns dielectric ceramics and a manufacturing method thereof, as well as a multi-layer capacitor using the dielectric ceramics and it relates to a composition capable of decreasing piezoelectricity.

2. Description of the Related Art

A multi-layer ceramic capacitor has multi-layer ceramics comprising a plurality of dielectric ceramic layers and a plurality of internal electrodes formed so as to be led to different end faces alternately by way of the dielectric ceramic layers, in which external electrodes are formed on both end faces of the multi-layer ceramics so as to be connected electrically with the internal electrodes.

Dielectric ceramics for use in such a multi-layer ceramic capacitor have piezoelectricity since they are ferroelectric substances. Accordingly, when a voltage is applied, a multi-layer ceramic capacitor 1′ displaces as shown in FIG. 2. The direction of displacement changes depending on the direction of the voltage to be applied. In FIG. 2, when positive voltage is applied to the external electrode on the left, for example, the capacitor elongates in the direction of the thickness and shrinks in the longitudinal direction as shown by a dotted line A. Then, when the positive voltage is applied to the external electrode on the right, the capacitor elongates in the longitudinal direction and shrinks in the direction of the thickness as shown by a dotted line B. Then, when the direction of the voltage changes continuously, the direction of the displacement also changes continuously and the capacitor elongates or shrinks so as to cause vibrations. Elongation and shrink in the longitudinal direction of the multi-layer ceramic capacitor generates minute distortion to a circuit substrate to which the multi-layer ceramic capacitor is mounted. In a case of using a multi-layer ceramic capacitor comprising such dielectric ceramics for an input capacitor to CPU of a personal computer or under a condition where voltage changes periodically as in an image processing circuit of a liquid crystal display or plasma display, minute distortion is generated in the circuit substrate in accordance with voltage change. Particularly, in a case where the period of voltage change is in an audible range from 20 Hz to 2 kHz, air is vibrated by the distortion of the substrate to generate noises referred to as ringing. Further, resonance occurs depending on the thickness and the material of the circuit substrate or the frequency to sometimes generate extremely large noises. The sounds were offensive to the ear and resulted in a problem of giving unpleasant feeling.

Then, for overcoming the ringing, it has been proposed a method as described, for example, in Japanese Unexamined Patent Publication No. Hei 8-055752, of mounting a multi-layer ceramic capacitor such that the internal electrodes thereof are in perpendicular to the surface of a circuit substrate thereby decreasing the effect of elongation and shrink of the multi-layer ceramic capacitor. Further, as has been disclosed in Japanese Unexamined Patent Publication No. 2000-232030, a method of mounting two multi-layer ceramic capacitors having identical characteristics to the surface and the rear face of a circuit substrate to offset vibrations with each other thereby overcoming the ringing has been proposed.

However, in the method disclosed in JP-A No. 8-055752, since vibrations of the multi-layer ceramic capacitor per se occur, the effect of causing minute distortions to the circuit substrate is left. Accordingly, elimination of ringing is difficult depending on the amount of displacement of the multi-layer ceramic capacitor. Further, in the method disclosed in JP-A No. 2000-232030, since the effect of offsetting distortions does not develop unless the phase of amplitude is conformed, the circuit design is difficult. Further, since the multi-layer ceramic capacitor per se vibrates, and this leaves an effect of generating minute distortions to the circuit substrate, it is difficult to eliminate ringing, like the method disclosed in JP-A No. 8-055752. Further, along with decrease in the size and increase in the capacitance of the multi-layer ceramic capacitors, it has become difficult to overcome the ringing by the device for the mounting method proposed so far.

The present invention provides dielectric ceramics in which the piezoelectricity is decreased such that displacement causing the ringing is decreased. Further, it provides a multi-layer ceramic capacitor capable of decreasing the occurrence of ringing by using the dielectric ceramics described above.

### SUMMARY OF THE INVENTION

In some embodiments, dielectric ceramics comprise a solid solution represented by Ba—Ti—Zr—Re-Me-O₃ (wherein Re is at least one metal element selected from La, Ce, Pr, Nd, Sm, Eu, Gd, Tb, Dy, Ho, Er, Tm, Yb, Lu and Y, Me is a metal element selected from Mg, Cr, and Mn, and Zr is an arbitrary ingredient), and SiO₂ in which Ti:Zr is from 100:0 to 75:25 as a molar ratio being converted as TiO₂ and converted as ZrO₂. Ba can be from 97 mol to 103 mol being converted as BaO assuming Ti+Zr as 100 mol being converted as an oxide. Re can be 2 mol to 18 mol being converted as an oxide containing a metal element by one atom in one molecule. Me can be from 2 mol to 18 mol being converted as an oxide containing a metal element by one atom in one molecule. SiO₂ can be from 0.5 mol to 10 mol. The dielectric ceramics can provide those of decreased piezoelectricity. Accordingly, dielectric ceramics with decreased displacement causing ringing can be obtained.

In other embodiments, a method of manufacturing dielectric ceramics can be provided including preparing TiO₂ and ZrO₂ such that Ti:Zr is from 100:0 to 75:25 by molar ratio, preparing a Ba compound by 97 mol to 103 mol being converted as BaO based on 100 mol of TiO₂+ZrO₂, preparing Re compound by 2 mol to 18 mol being converted as an oxide containing a metal element by one atom in one molecule, preparing an Me compound by from 2 mol to 18 mol being converted as an oxide containing a metal element by one atom in one molecule, mixing and calcining each of the prepared compounds: Ba, Ti, Zr, Re, and Me, and mixing SiO₂ to the calcined mixture so as to be 0.5 mol to 10 mol based on 100 mol of Ti+Zr. According to the manufacturing method of the dielectric ceramics, the piezoelectricity of the dielectric ceramics can be decreased. Accordingly, displacement causing ringing can be decreased.

In further embodiments, a multi-layer ceramic capacitor comprises a plurality of dielectric ceramic layers, internal electrodes formed between the dielectric ceramic layers and external electrodes connected electrically to the internal electrodes, in which the dielectric ceramic layer is formed of the dielectric ceramics shown above, and the internal electrodes are formed of Ni or an Ni alloy. In the multi-layer ceramic capacitor, since dielectric ceramics decreased for the piezoelectricity can be used for the dielectric ceramic layer, a multi-layer ceramic capacitor decreased for the displacement causing ringing and decreased for the occurrence of ringing can be obtained.

According one embodiment of the invention, dielectric ceramics decreased for the piezoelectricity can be obtained. Further, a multi-layer ceramic capacitor decreased for the occurrence of ringing can be obtained by using the dielectric ceramics described above. Further, according to the manufacturing method of the invention, dielectric ceramics decreased for the piezoelectricity can be obtained, and dielectric material capable of obtaining a multi-layer ceramic capacitor decreased for the displacement causing the ringing can be obtained.

### BRIEF DESCRIPTION OF THE DRAWINGS

FIG. 1 is a view schematically showing a cross section of a multi-layer ceramic capacitor; and

FIG. 2 is a view showing a state where displacement caused by piezoelectricity occurs in the multi-layer ceramic capacitor.

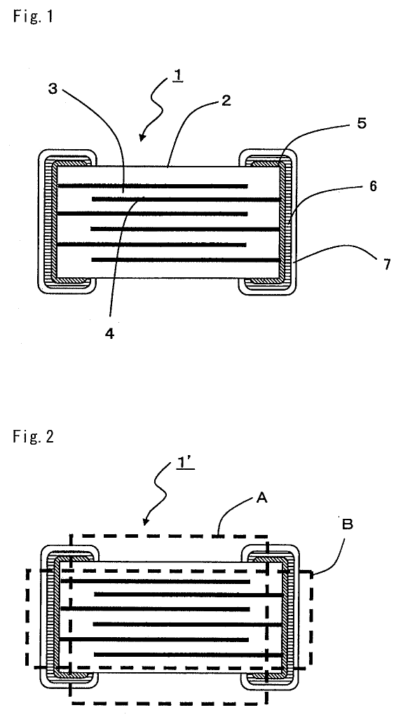

### DETAILED DESCRIPTION OF THE PREFERRED EMBODIMENT

In an embodiment, the dielectric ceramics comprise a solid solution represented by Ba—Ti—Zr—Re-Me-O₃ (wherein Re is at least one metal element selected from La, Ce, Pr, Nd, Sm, Eu, Gd, Tb, Dy, Ho, Er, Tm, Yb, Lu and Y, Me is a metal element selected from Mg, Cr, and Mn, and Zr is an arbitrary ingredient), and SiO₂ as a sintering aid. Zr can be an arbitrary ingredient which may be present or not present in the solid solution. Hence, Ba—Ti—Re-Me-O₃ may also be used.

In some embodiments, the Ti ingredient and the Zr ingredient can be Ti:Zr=100:0 to 75:25 by molar ratio when Ti is converted as TiO₂ and Zr is converted as ZrO₂. Since Zr need not be involved, it may be 0, but the sinterability of dielectric ceramics can be lowered when the molar ratio to Ti exceeds 25. TiO₂ can be used as the starting material for the Ti ingredient. Further, ZrO₂ can be used as the starting material for Zr ingredient.

In one embodiment, the Ba ingredient can be from 97 mol to 103 mol being converted as BaO based on 100 mol of Ti+Zr. In a case where the Ba ingredient is less than 97 mol or more than 103 mol, the sinterability of the dielectric ceramics is lowered. As the starting material for the Ba ingredient, BaCO₃ can be used in addition to BaO.

In one embodiment, the Re ingredient can be at least one rare earth metal element selected from La, Ce, Pr, Nd, Sm, Eu, Gd, Tb, Dy, Ho, Er, Tm, Yb, Lu and Y, and it can be from 2 mol to 18 mol being converted as an oxide containing a metal element by one atom in one molecule based on 100 mol of Ti+Zr. “Being converted as an oxide containing a metal element by one atom in one molecule” means conversion to an oxide having one metal atom in one molecule. For example, Ho₂O₃ is converted as HoO_{3/2}. In a case where the Re ingredient is less than 2 mol, displacement of the dielectric ceramics increases to generate ringing. On the other hand, if it exceeds 18 mol, the sinterability of the dielectric ceramics is lowered. Respective trivalent oxides, that is, oxides represented by Re₂O₃ can be used as the starting material for the Re.

In further embodiments, the Me ingredient can be a metal element selected from Mg, Cr, and Mn and can be from 2 to 18 mol being converted as an oxide containing a metal element by one atom in one molecule based on 100 mol of Ti+Zr. In a case where the Me ingredient is less than 2 mol or more than 18 mol, the sinterability of the dielectric ceramics can be lowered. As the starting material for the Me ingredient, MgO can be used in a case of Mg. Cr₂O₃ can be used in a case of Cr. In a case of Mn, MnCO₃, Mn₃O₄ can be used in addition to MnO.

In some embodiments, SiO₂ functions as a sintering aid of sintering a solid solution to form dielectric ceramics after forming the solid solution for the Ba ingredient, Ti ingredient, Zr ingredient, Re ingredient, and Me ingredient. The addition amount can be from 0.5 mol to 10 mol based on 100 mol of Ti+Zr. In a case where SiO₂ is less than 0.5 mol or more than 10 mol, the sinterability of the dielectric ceramics can be lowered.

In one embodiment, a multi-layer ceramic capacitor 1 has multi-layer ceramics 2 of a substantially hexahedral shape having dielectric ceramics 3 and internal electrodes 4 formed such that they are opposed by way of the dielectric ceramics 3 and led alternately to different end faces. External electrodes 5 can be formed on both end faces of the multi-layer ceramics 2 so as to be connected electrically with the internal electrodes. A first plating layer 6 for protecting the external electrode 5 and a second plating layer 7 for improving the solder wettability can be formed optionally on the external electrode 5.

In another embodiment, the dielectric ceramics 3 can be formed of dielectric ceramics of the invention. Generally, the magnitude of the displacement due to the piezoelectricity can be in proportion to the intensity of electric field×piezo-electric distortion constant. In the dielectric ceramics of the invention, the piezo-electric distortion constant can be decreased by lowering the piezoelectricity and, as a result, the displacement amount under an identical intensity of electric field can be decreased.

In one embodiment, a decrease in the piezoelectricity can be attained by a method of forming a solid solution of a Ba ingredient, Ti ingredient, Zr ingredient, Re ingredient, and Me ingredient, and suppressing the grain growth of the solid solution by the Me ingredient. By forming the solid solution containing the Re ingredient and the Me ingredient, formation of a ferrodielectric phase such as BaTiO₃ or BaTiZrO₃ can be inhibited, and increase of the piezoelectricity due to the grain growth is suppressed.

In another embodiment, the internal electrode 4 can be formed of the Ni or an Ni alloy such as an Ni—Cu alloy. Since Ni or Ni alloy has a melting point higher than the sintering temperature of dielectric ceramics (1,100° C. to 1,400° C.), it can be baked simultaneously with the baking of the dielectric ceramics. Further, since this is less expensive compared with Pd or the like, a multi-layer ceramic capacitor of a large capacitance in which the number of sheets for the internal electrodes is increased can be obtained at a low cost.

In one embodiment, the external electrode 5 can be electrically connected with the internal electrode 4. The external electrode 5 can be formed by a method of using a paste such as of Ni having a melting point higher than the sintering temperature of the dielectric ceramics and baking at the same time with the baking of the dielectric ceramics, or a method of sintering the multi-layer ceramics 2 and then firing them by using an Ag paste or Cu paste. A first plating layer 6 for protecting the external electrode 5 can be formed on the external electrode 5 and, further, a second plating layer 7 can be formed on the first plating layer 6. For the first plating layer 6, a metal such as Ni, or Cu can be used and, as the second plating layer, a metal of good solder wetting property such as Sn or Sn alloy can be used.

In some embodiments, TiO₂ and ZrO₂ can be prepared such that Ti:Zr is from 100:0 to 75:25 by molar ratio. From 97 mol to 103 mol of BaO, from 2 to 18 mol of Ho₂O₃ being converted as HoO_{3/2} as the Re ingredient, and from 2 to 18 mol of MgO as the Me ingredient can be prepared based on 100 mol of TiO₂+ZrO₂. Water can be added to the prepared BaO, TiO₂, ZrO₂, Ho₂O₃, and MgO and wet-mixed for about 15 to 24 hr by using, for example, a ball mill, beads mill or disper mill. The obtained mixture can be dried and then calcined at 1100° C. to 1250° C. for about 2 hr to obtain a calcined mixture.

In other embodiments, from 0.5 mol to 10 mol of SiO₂ can be mixed based on 100 mol of TiO₂+ZrO₂ to the calcined mixture, water can be added and wet-mixed for about 15 to 24 hr by using a ball mill, beads mill, disper mill or the like. Then, they can be dried to obtain a dielectric ceramic composition.

In further embodiments, the obtained dielectric ceramic composition can be mixed with a butyral or acrylic organic binder, a solvent, and other additives to form a ceramic slurry. The ceramic slurry can be sheeted by using a coating device such as a roll coater to form a ceramic green sheet of a predetermined thickness as the dielectric ceramic layer 3. A conductive paste of Ni or an Ni alloy can be coated on the ceramic green sheet in a predetermined patterned shape by screen printing to form a conductive layer as the internal electrode 4.

In one embodiment, after laminating ceramic green sheets each formed with the conductive layer by a required number of sheets, they can be press bonded to form a raw layered body. After cutting and dividing the layered body into individual chips, the binder can be removed in an atmospheric air or a non-oxidative gas such as nitrogen. After removing the binder, a conductive paste can be coated to the internal electrode exposure surface of an individual chip to form a conductive film as the external electrode 5. The individual chip formed with the conductive film can be baked in a nitrogen-hydrogen atmosphere (oxygen partial pressure: about 10⁻¹⁰ atm) at a predetermined temperature. The external electrode 5 may also be formed by baking the individual chip to form multi-layer ceramics 2, and then coating and firing a conductive paste containing glass frits to the internal electrode exposure surface. For the external electrode 5, metals identical with those of the internal electrode can be used, as well as Ag, Pd, AgPd, Cu, Cu alloy or the like can be used. Further, a first plating layer 6 is formed with Ni, Cu or the like on the external electrode 5 and, a second plating layer 7 such as of Sn or Sn alloy can be formed further thereon to obtain a multi-layer ceramic capacitor 1.

### EXAMPLES

### Example 1

101 mol of BaO, 87 mol of TiO₂, 13 mol of ZrO₂, 5 mol of Ho₂O₃, and 2.5 mol of MgO were weighed and prepared respectively as the starting material of Example 1. Then, the prepared starting materials were wet mixed for 15 hr in a ball mill and, after drying, calcined at 1200° C. for 2 hr to obtain a powder of a main ingredient. Then, 3 mol of SiO₂ was added to the obtained powder of the main ingredient, the mixture was wet-mixed in a ball mill and dried to obtain dielectric ceramic powder.

Polyvinyl butyral, an organic solvent, and a plasticizer were added and mixed to the powder to form a ceramic slurry. The ceramic slurry was sheeted by a roll coater to obtain a ceramic green sheet of 8 μm thickness. An Ni internal electrode paste was coated by screen printing on the ceramic green sheet to form an internal electrode pattern. Ceramic green sheets each formed with the internal electrode pattern were stacked by the number of 300 sheets, ceramic green sheets not formed with the internal electrode pattern were further stacked above and below of them and press-bonded being stacked by the number of 10 respectively, and they were cut and divided each into 4.0×2.0 mm size to form a raw chips. The binder was removed from the raw chips in the nitrogen atmosphere, an Ni external electrode paste was coated and baked in a reducing atmosphere (nitrogen-hydrogen atmosphere, oxygen partial pressure: 10⁻¹⁰ atm) at 1330° C. for 1 hr and then the temperature was lowered to a room temperature at a temperature-fall speed of 750° C./hr. In this way, a multi-layer ceramic capacitor of Example 1 sized 3.2×1.6 mm was obtained.

Then, as Example 2, starting materials of Example 1 in which Ho₂O₃ was changed to 2 mol and MgO was changed to 2 mol were weighed and prepared and the subsequent steps were carried out in the same manner as Example 1. As described 1, the multi-layer ceramic capacitor of Example 2 was thus obtained.

Then, as the starting materials for Comparative Example 1, 101 mol of BaO, 87 mol of TiO₂, and 13 mol of ZrO₂ were weighed respectively and prepared. Then, the prepared starting materials were wet-mixed in a ball mill for 15 hr and, after drying, calcined at 1150° C. for 2 hr to obtain a powder of Ba_{1.01}(Ti_{0.87}Zr_{0.13})O₃ as the main phase. Then, 5 mol of Ho₂O₃, 2.5 mol of MgO, and 3 mol of SiO₂ were added to the obtained powder of the main ingredient, the mixture was wet-mixed in a ball mill and dried to obtain a dielectric ceramic powder. The subsequent steps were carried out in the same manner as in Example 1 by using the obtained powder. As described above, a multi-layer ceramic capacitor of Comparative Example 1 was obtained.

Then, as Comparative Example 2, the amount of Ho₂O₃ was changed to 2 mol and the amount of MgO was changed to 2 mol in Comparative Example 1 and the subsequent steps were conducted in the same manner as in Example 1. As described above, a multi-layer ceramic capacitor of Comparative Example 2 was obtained. Compositions for Example 1 and Example 2 are shown in Table 1 and Compositions for Comparative Example 1 and Comparative Example 2 are shown in Table 2.

TABLE 1

| | | | | Re | | Me | | |
|---|---|---|---|---|---|---|---|---|
| | BaO | TiO₂ | ZrO₂ | ingredient | Amount | ingredient | Amount | SiO₂ |
| Example 1 | 101 | 87 | 13 | Ho₂O₃ | 5 | MgO | 2.5 | 3 |
| Example 2 | 101 | 87 | 13 | Ho₂O₃ | 2 | MgO | 2 | 3 |

TABLE 2

| | | Re | | Me | | |
|---|---|---|---|---|---|---|
| | Main phase | ingredient | Amount | ingredient | Amount | SiO₂ |
| Comparative | Ba_{1.01}(Ti_{0.87}Zr_{0.13})O₃ | Ho₂O₃ | 5 | MgO | 2.5 | 3 |
| Example 1 | | | | | | |
| Comparative | Ba_{1.01}(Ti_{0.87}Zr_{0.13})O₃ | Ho₂O₃ | 2 | MgO | 2 | 3 |
| Example 2 | | | | | | |

For the thus obtained multi-layer ceramic capacitors sized 3.2×1.6×1.6 mm with a thickness of 4 μm for the dielectric ceramic layer, permittivity (∈r), tan δ, and the displacement in the longitudinal direction were measured. The permittivity was calculated by preparing multi-layer ceramic capacitors as the sample by the number of 10 and measuring the electrostatic capacity for each of them by LCR meter 4284A manufactured by Hewlett-Packard Co. and, based on the measured value, the intersection area of the internal electrodes in the multi-layer ceramic capacitor as the sample, and the thickness and the number of lamination of the dielectric ceramic layer, and it was defined as an average value for the samples by the number of 10. For tan δ, measured value for the samples by the number of 10 were determined by measuring by LCR meter 4284A manufactured by Hewlett-Packard Co. and calculated as an average value thereof. Tan δ is used for judging the sinterability of the dielectric ceramics and the multi-layer ceramic capacitor and those exceeding 7.0% were judged as failed products.

For the displacement in the longitudinal direction, terminal end of a multi-layer ceramic capacitor sized 3.2×1.6×1.6 mm was disposed to a fixed substrate, and the displacement amount in the longitudinal direction was measured by a laser displacement meter when an AC voltage at 5V, 500 Hz was applied while superimposing a DC voltage at 20V. Measurement was carried out for the samples by the number of five and an average value of them was determined as data. For the threshold value in view of a relation between the absence or presence of ringing and the displacement amount, in a case where a multi-layer ceramic capacitor sized 3.2×1.6×1.6 mm was vibrated on a glass-epoxy substrate of 100 mm length×40 mm width×0.5 mm thickness, the displacement amount where the sound pressure of the generated sound was lower than 20 dB was judged as a good product and the value was defined as 10 nm.

Table 3 collectively shows measured values for the permittivity, tan δ, and the displacement amount for each of Example 1, Example 2, Comparative Example 1 and Comparative Example 2.

TABLE 3

| | Baking | | | Displace- | |
|---|---|---|---|---|---|
| | temperature | \acute{ε}r | Tan δ (%) | ment (nm) | Judgment |
| Example 1 | 1330 | 1203 | 0.65 | 3.5 | ∘ |
| Example 2 | 1285 | 1532 | 1.24 | 5.8 | ∘ |
| Comparative | 1330 | 1210 | 0.87 | 16.7 | x |
| Example 1 | | | | | |
| Comparative | 1285 | 1529 | 1.37 | 25.3 | x |
| Example 2 | | | | | |

From the result of Table 3, it has been found that the displacement amount in the longitudinal direction is 10 nm or less and the ringing can be decreased in the multi-layer ceramic capacitor of the invention. When dielectric ceramics constituting multi-layer ceramic capacitors of Example 1, Example 2, Comparative Example 1 and Comparative Example 2 were observed by TEM (transmission type electron microscope)+EDX detector, the dielectric ceramic particles of Example 1 and Example 2 were solid solutions in which Ba, Ti, Zr, Re ingredients, and Me ingredient were distributed substantially uniformly. On the other hand, dielectric ceramic particles of Comparative Example 1 and Comparative Example 2 were so-called core-shell particles having BaTiZrO₃ core and having a shell to the periphery of the core in which Ba, Ti, Zr, Re ingredients and Me ingredient were distributed substantially uniformly.

### Example 2

Dielectric ceramic powders were formed so as to obtain sintered bodies of compositions shown in Table 4 in the same manner as in Example 1 of Embodiment 1 both for the examples and comparative examples. The effect was demonstrated by changing the addition amount and the type of Re. In Example 23, Ho₂O₃ was mixed by 2 mol and Gd₂O₃ was mixed by 5 mol. In Example 24, Ho₂O₃ was mixed by 2 mol and Gd₂O₃ was mixed by 5 mol and, Dy₂O₃ was mixed by 5 mol.

TABLE 4

| | | | | Re | | Me | | |
|---|---|---|---|---|---|---|---|---|
| | BaO | TiO₂ | ZrO₂ | ingredient | Amount | ingredient | Amount | SiO₂ |
| Comparative | 101 | 87 | 13 | Ho₂O₃ | 1.5 | MgO | 2. | 3 |
| Example 3 | | | | | | | | |
| Example 3 | 101 | 87 | 13 | Ho₂O₃ | 2 | MgO | 2 | 3 |
| Example 4 | 101 | 87 | 13 | Ho₂O₃ | 5 | MgO | 2.5 | 3 |
| Example 5 | 101 | 87 | 13 | Ho₂O₃ | 7 | MgO | 3.5 | 3 |
| Example 6 | 101 | 87 | 13 | Ho₂O₃ | 12 | MgO | 6 | 3 |
| Example 7 | 101 | 87 | 13 | Ho₂O₃ | 18 | MgO | 9 | 3 |
| Comparative | 101 | 87 | 13 | Ho₂O₃ | 20 | MgO | 10 | 3 |
| Example 4 | | | | | | | | |
| Example 8 | 101 | 87 | 13 | La₂O₃ | 5 | MgO | 2.5 | 3 |
| Example 9 | 101 | 87 | 13 | Ce₂O₃ | 5 | MgO | 2.5 | |
| Example 10 | 101 | 87 | 13 | Pr₂O₃ | 5 | MgO | 2.5 | 3 |
| Example 11 | 101 | 87 | 13 | Nd₂O₃ | 5 | MgO | 2.5 | 3 |
| Example 12 | 101 | 87 | 13 | Sm₂O₃ | 5 | MgO | 2.5 | 3 |
| Example 13 | 101 | 87 | 13 | Eu₂O₃ | 5 | MgO | 2.5 | 3 |
| Example 14 | 101 | 87 | 13 | Gd₂O₃ | 5 | MgO | 2.5 | 3 |
| Example 15 | 101 | 87 | 13 | Tb₂O₃ | 5 | MgO | 2.5 | 3 |
| Example 16 | 101 | 87 | 13 | Dy₂O₃ | 5 | MgO | 2.5 | 3 |
| Example 17 | 101 | 87 | 13 | Ho₂O₃ | 5 | MgO | 2.5 | 3 |
| Example 18 | 101 | 87 | 13 | Er₂O₃ | 5 | MgO | 2.5 | 3 |
| Example 19 | 101 | 87 | 13 | Tm₂O₃ | 5 | MgO | 2.5 | 3 |
| Example 20 | 101 | 87 | 13 | Yb₂O₃ | 5 | MgO | 2.5 | 3 |
| Example 21 | 101 | 87 | 13 | Lu₂O₃ | 5 | MgO | 2.5 | 3 |
| Example 22 | 101 | 87 | 13 | Y₂O₃ | 5 | MgO | 2.5 | 3 |
| Example 23 | 101 | 87 | 13 | Ho₂O₃, | 2:5 | MgO | 2.5 | 3 |
| | | | | Gd₂O₃ | | | | |
| Example 24 | 101 | 87 | 13 | Ho₂O₃, | 2:5:5 | MgO | 2.5 | 3 |
| | | | | Gd₂O₃, | | | | |
| | | | | Dy₂O₃ | | | | |

Then, multi-layer ceramic capacitors were formed using the dielectric ceramic powders described above in the same manner as in Example 1, and permittivity, tan δ, and the displacement amount in the longitudinal direction were measured and collectively shown in Table 5.

TABLE 5

| | Baking | | | Displace- | |
|---|---|---|---|---|---|
| | temperature | \acute{ε}r | Tan δ (%) | ment (nm) | Judgment |
| Comparative | 1290 | 1523 | 5.4 | 12.3 | x |
| Example 3 | | | | | |
| Example 3 | 1285 | 1532 | 1.24 | 5.8 | ∘ |
| Example 4 | 1330 | 1203 | 0.65 | 3.5 | ∘ |
| Example 5 | 1340 | 1009 | 0.53 | 3.2 | ∘ |
| Example 6 | 1350 | 758 | 0.51 | 2.2 | ∘ |
| Example 7 | 1360 | 306 | 5.3 | 0.9 | ∘ |
| Comparative | 1360 | 314 | 8.2 | 0.8 | x |
| Example 4 | | | | | |
| Example 8 | 1320 | 1254 | 0.89 | 4.3 | ∘ |
| Example 9 | 1305 | 1324 | 1.01 | 5.3 | ∘ |
| Example 10 | 1330 | 1185 | 0.94 | 3.4 | ∘ |
| Example 11 | 1320 | 1224 | 1.21 | 3.8 | ∘ |
| Example 12 | 1325 | 1314 | 0.99 | 4.1 | ∘ |
| Example 13 | 1320 | 1275 | 1.02 | 3.6 | ∘ |
| Example 14 | 1310 | 1324 | 0.94 | 4.5 | ∘ |
| Example 15 | 1300 | 1330 | 1.03 | 3.2 | ∘ |
| Example 16 | 1325 | 1265 | 0.85 | 2.9 | ∘ |
| Example 17 | 1310 | 1335 | 1.21 | 3.8 | ∘ |
| Example 18 | 1335 | 1305 | 0.59 | 4.1 | ∘ |
| Example 19 | 1300 | 1298 | 0.64 | 5.2 | ∘ |
| Example 20 | 1315 | 1275 | 0.85 | 2.5 | ∘ |
| Example 21 | 1325 | 1310 | 0.94 | 3.5 | ∘ |
| Example 22 | 1320 | 1253 | 1.13 | 2.6 | ∘ |
| Example 23 | 1340 | 1383 | 1.35 | 4.1 | ∘ |
| Example 24 | 1355 | 1245 | 1.43 | 4.9 | ∘ |

From the results of Examples 3 to 7 and Comparative Example 3 and Comparative Example 4, it has been found that the displacement amount exceeds 10 mm when the Re ingredient is less than 2 mol, and the sinterability is worsened and tan δ exceeds 7.0% when Re ingredient exceeds 18 mol. It has been found from the foregoing, that the Re ingredient is preferably within a range from 2 to 18 mol. Further, from the results of Examples 8 to 22, it has been found that the same effect can be obtained when the Re ingredient is changed to those other than Ho. Further, from the results of Example 23 and Example 24, it can be seen that the same result can be obtained also by mixing two or more types of the Re ingredients.

### Example 3

Dielectric ceramic powders were formed so as to obtain sintered bodies of compositions shown in Table 6 in the same manner as Example 1 of Embodiment 1 both for examples and comparative examples. In this case, the addition amount of the Zr ingredient was changed and the effect was demonstrated. Example 25 does not contain the Zr ingredient.

TABLE 6

| | | | | Re | | Me | | |
|---|---|---|---|---|---|---|---|---|
| | BaO | TiO₂ | ZrO₂ | ingredient | Amount | ingredient | Amount | SiO₂ |
| Example 25 | 101 | 100 | 0 | Ho₂O₃ | 18 | MgO | 9 | 3 |
| Example 26 | 101 | 87 | 13 | Ho₂O₃ | 18 | MgO | 9 | 3 |
| Example 27 | 101 | 80 | 20 | Ho₂O₃ | 18 | MgO | 9 | 3 |
| Example 28 | 101 | 75 | 25 | Ho₂O₃ | 18 | MgO | 9 | 3 |
| Comparative | 101 | 70 | 30 | Ho₂O₃ | 18 | MgO | 9 | 3 |
| Example 5 | | | | | | | | |

Multi-layer ceramic capacitors were formed using the dielectric ceramic powders as described above in the same manner as in Embodiment 1, and permittivity, tan δ, and the displacement amount in the longitudinal direction were measured and collectively shown in Table 7.

TABLE 7

| | Baking | | | Displace- | |
|---|---|---|---|---|---|
| | temperature | \acute{ε}r | Tan δ (%) | ment (nm) | Judgment |
| Example 25 | 1330 | 705 | 2.2 | 9.5 | ∘ |
| Example 26 | 1360 | 306 | 0.35 | 0.9 | ∘ |
| Example 27 | 1340 | 259 | 0.45 | 0.8 | ∘ |
| Example 28 | 1360 | 238 | 1.53 | 0.8 | ∘ |
| Comparative | 1360 | 219 | 9.4 | 0.8 | x |
| Example 5 | | | | | |

From the results of Table 7, it has been found that the displacement amount is decreased to less than 10 nm in a case where the ratio of the Ti ingredient and the Zr ingredient is within a range of from 100:0 to 75:25 by molar ratio. It has been found that when the ratio of the Zr ingredient exceeds 25, the sinterability is worsened and tan δ exceeds 7.0%.

### Example 4

Dielectric ceramic powders were formed so as to obtain sintered bodies of compositions shown in Table 8 in the same manner as Example 1 of Embodiment 1 both for examples and comparative examples. In this case, the addition amount of the Ba ingredient was changed and the effect was demonstrated. Examples 28 to 31 and Comparative Example 6 and Comparative Example 7 are dielectric ceramics not containing the Zr ingredient, and Examples 32 to 35, and Comparative Example 8 and Comparative Example 9 are dielectric ceramics containing Zr ingredient.

TABLE 8

| | | | | Re | | Me | | |
|---|---|---|---|---|---|---|---|---|
| | BaO | TiO₂ | ZrO₂ | ingredient | Amount | ingredient | Amount | SiO₂ |
| Comparative | 96 | 100 | 0 | Ho₂O₃ | 5 | MgO | 2.5 | 3 |
| Example 6 | | | | | | | | |
| Example 29 | 97 | 100 | 0 | Ho₂O₃ | 5 | MgO | 2.5 | 3 |
| Example 30 | 99 | 100 | 0 | Ho₂O₃ | 5 | MgO | 2.5 | 3 |
| Example 31 | 101 | 100 | 0 | Ho₂O₃ | 5 | MgO | 2.5 | 3 |
| Example 32 | 103 | 100 | 0 | Ho₂O₃ | 5 | MgO | 2.5 | 3 |
| Comparative | 104 | 100 | 0 | Ho₂O₃ | 5 | MgO | 2.5 | 3 |
| Example 7 | | | | | | | | |
| Comparative | 96 | 80 | 20 | Ho₂O₃ | 5 | MgO | 2.5 | 3 |
| Example 8 | | | | | | | | |
| Example 33 | 97 | 80 | 20 | Ho₂O₃ | 5 | MgO | 2.5 | 3 |
| Example 34 | 99 | 80 | 20 | Ho₂O₃ | 5 | MgO | 2.5 | 3 |
| Example 35 | 101 | 80 | 20 | Ho₂O₃ | 5 | MgO | 2.5 | 3 |
| Example 36 | 103 | 80 | 20 | Ho₂O₃ | 5 | MgO | 2.5 | 3 |
| Comparative | 104 | 80 | 20 | Ho₂O₃ | 5 | MgO | 2.5 | 3 |
| Example 9 | | | | | | | | |

Then, multi-layer ceramic capacitors were formed by using the dielectric ceramic powders in the same manner as in Embodiment 1, and permittivity, tan δ, and the displacement amount in the longitudinal direction were measured and collectively shown in Table 9.

TABLE 9

| | Baking | | | Displace- | |
|---|---|---|---|---|---|
| | temperature | \acute{ε}r | Tan δ (%) | ment (nm) | Judgment |
| Comparative | 1330 | 1730 | 8.23 | 5.3 | x |
| Example 6 | | | | | |
| Example 29 | 1330 | 1643 | 4.55 | 5.2 | ∘ |
| Example 30 | 1330 | 1622 | 1.03 | 5.2 | ∘ |
| Example 31 | 1330 | 1598 | 1.34 | 5.3 | ∘ |
| Example 32 | 1330 | 1589 | 4.68 | 5.9 | ∘ |
| Comparative | 1330 | 1684 | 7.45 | 5.3 | x |
| Example 7 | | | | | |
| Comparative | 1330 | 1134 | 10.34 | 1.3 | x |
| Example 8 | | | | | |
| Example 33 | 1330 | 1099 | 4.86 | 1.5 | ∘ |
| Example 34 | 1330 | 1104 | 0.75 | 1.4 | ∘ |
| Example 35 | 1330 | 1124 | 0.63 | 1.3 | ∘ |
| Example 36 | 1330 | 1156 | 4.88 | 1.2 | ∘ |
| Comparative | 1330 | 1186 | 9.56 | 1.1 | x |
| Example 9 | | | | | |

From the results of Table 9, it has been found that the sinterability is worsened and tan δ exceeds 7.0% in a case where the Ba ingredient is less than 97 mol and in a case where it exceeds 103 mol. Accordingly, it has been found that dielectric ceramics of favorable sinterability and multi-layer ceramic capacitors having the displacement amount of less than 10 nm can be obtained in a case where the Ba ingredient is within a range from 97 mol to 103 mol.

### Example 5

Dielectric ceramic powders were formed so as to obtain sintered bodies of compositions shown in Table 10 in the same manner as Example 1 of Embodiment 1 both for examples and comparative examples.

In this case, the addition amount and the type of Me were changed and the effect thereof was demonstrated. In Example 43, MgO was mixed by 2.5 mol and MnO was mixed by 0.5 mol. Further, in Example 44, 2.5 mol of MgO, 0.5 mol of MnO, 0.25 mol of Cr₂O₃ (0.5 mol being converted as CrO_{3/2}) were mixed. Further, the addition amount of Cr₂O₃ in Example 42 was 2.5 mol being converted as CrO_{3/2}.

TABLE 10

| | | | | Re | | Me | | |
|---|---|---|---|---|---|---|---|---|
| | BaO | TiO₂ | ZrO₂ | ingredient | Amount | ingredient | Amount | SiO₂ |
| Comparative | 101 | 87 | 13 | Ho₂O₃ | 5 | MgO | 1.5 | 3 |
| Example 10 | | | | | | | | |
| Example 37 | 101 | 87 | 13 | Ho₂O₃ | 5 | MgO | 2 | 3 |
| Example 38 | 101 | 87 | 13 | Ho₂O₃ | 5 | MgO | 2.5 | 3 |
| Example 39 | 101 | 87 | 13 | Ho₂O₃ | 5 | MgO | 7 | 3 |
| Example 40 | 101 | 87 | 13 | Ho₂O₃ | 5 | MgO | 12 | 3 |
| Example 41 | 101 | 87 | 13 | Ho₂O₃ | 5 | MgO | 18 | 3 |
| Comparative | 101 | 87 | 13 | Ho₂O₃ | 5 | MgO | 20 | 3 |
| Example 11 | | | | | | | | |
| Example 42 | 101 | 87 | 13 | Ho₂O₃ | 5 | MnO | 2.5 | 3 |
| Example 43 | 101 | 87 | 13 | Ho₂O₃ | 5 | Cr₂O₃ | 1.25 | 3 |
| Example 44 | 101 | 87 | 13 | Ho₂O₃ | 5 | MgO:MnO | 2.5:0.5 | 3 |
| Example 45 | 101 | 87 | 13 | Ho₂O₃ | 5 | MgO:MnO:Cr₂O₃ | 2.5:0.5:0.25 | 3 |

Multi-layer ceramic capacitors were formed by using the dielectric ceramic powders described above in the same manner as in Embodiment 1, and permittivity, tan δ, and the displacement amount in the longitudinal direction were measured and collectively shown in Table 11.

TABLE 11

| | Baking | | | Displace- | |
|---|---|---|---|---|---|
| | temperature | \acute{ε}r | Tan δ (%) | ment (nm) | Judgment |
| Comparative | 1325 | 1242 | 8.14 | 4.3 | x |
| Example 10 | | | | | |
| Example 37 | 1325 | 1235 | 4.22 | 5.2 | ∘ |
| Example 38 | 1330 | 1203 | 0.65 | 3.5 | ∘ |
| Example 39 | 1330 | 1207 | 0.58 | 3.4 | ∘ |
| Example 40 | 1330 | 1210 | 0.89 | 3.3 | ∘ |
| Example 41 | 1335 | 1214 | 4.68 | 2.8 | ∘ |
| Comparative | 1335 | 1195 | 7.94 | 3.1 | x |
| Example 11 | | | | | |
| Example 42 | 1320 | 1212 | 0.94 | 3.5 | ∘ |
| Example 43 | 1315 | 1324 | 0.75 | 2.4 | ∘ |
| Example 44 | 1320 | 1324 | 0.88 | 5.9 | ∘ |
| Example 45 | 1330 | 1234 | 1.03 | 6.7 | ∘ |

From the results of Examples 36 to 40 and Comparative Example 10 and Comparative Example 11, it has been found that the sinterability is worsened and tan δ exceeds 7.0% when the Me ingredient is less than 2 mol and exceeds 18 mol. It has been found from the foregoings that the Me ingredient is preferably within a range from 2 to 18 mol. Further, from the results of Example 41 and Example 42, it has been found that the same effect can also be obtained when the Me ingredient is changed to those other than Mg. Further, from the results of Example 43 and Example 44, the same result can be obtained also by mixing two or more types of the Me ingredients

### Example 6

Dielectric ceramic powders were formed so as to obtain sintered bodies of compositions shown in Table 12 in the same manner as Example 1 of Embodiment 1 both for examples and comparative examples. In this case, the addition amount of SiO₂ was changed and the effect thereof was demonstrated.

TABLE 12

| | | | | Re | | Me | | |
|---|---|---|---|---|---|---|---|---|
| | BaO | TiO₂ | ZrO₂ | ingredient | Amount | ingredient | Amount | SiO₂ |
| Comparative | 101 | 87 | 13 | Ho₂O₃ | 5 | MgO | 2.5 | 0.3 |
| Example 12 | | | | | | | | |
| Example 46 | 101 | 87 | 13 | Ho₂O₃ | 5 | MgO | 2.5 | 0.5 |
| Example 47 | 101 | 87 | 13 | Ho₂O₃ | 5 | MgO | 2.5 | 3 |
| Example 48 | 101 | 87 | 13 | Ho₂O₃ | 5 | MgO | 2.5 | 7 |
| Example 49 | 101 | 87 | 13 | Ho₂O₃ | 5 | MgO | 2.5 | 10 |
| Comparative | 101 | 87 | 13 | Ho₂O₃ | 5 | MgO | 2.5 | 15 |
| Example 13 | | | | | | | | |

Then, multi-layer ceramic capacitors were formed using the dielectric ceramic powders in the same manner as in Embodiment 1, permittivity, tan δ, and the displacement amount in the longitudinal direction were measured and collectively shown in Table 13.

TABLE 13

| | Baking | | | Displace- | |
|---|---|---|---|---|---|
| | temperature | \acute{ε}r | Tan δ (%) | ment (nm) | Judgment |
| Comparative | 1360 | 1140 | 10.43 | 2.6 | x |
| Example 12 | | | | | |
| Example 46 | 1320 | 1202 | 6.57 | 3.4 | ∘ |
| Example 47 | 1330 | 1203 | 0.65 | 3.5 | ∘ |
| Example 48 | 1300 | 1173 | 3.19 | 3.3 | ∘ |
| Example 49 | 1250 | 1140 | 5.45 | 2.6 | ∘ |
| Comparative | 1220 | 1068 | 7.25 | 3.4 | x |
| Example 13 | | | | | |

From the results of Table 13, it has been found that the sinterability is worsened and tan δ exceeds 7.0% in a case where the SiO₂ is less than 0.5 mol and in a case where it exceeds 10 mol. Accordingly, it has been found that dielectric ceramics of favorable sinterability and multi-layer ceramic capacitors having the displacement amount of less than 10 nm can be obtained in a case where the SiO₂ is within a range from 0.5 mol to 10 mol.

What is claimed is:

1. A Dielectric ceramics comprising:
SiO₂ and a solid solution represented by:
Ba—Ti—Zr—Re-Me-O₃
where Re is at least one metal element selected from La, Ce, Pr, Nd, Sm, Eu, Gd, Tb, Dy, Ho, Er, Tm, Yb, Lu and Y, Me is at least one metal element selected from Mg, Cr, and Mn;
Ti:Zr is from 100:0 to 75:25 as a molar ratio being converted as TiO₂ and being converted as ZrO₂;
Ti+Zr as 100 mol being converted as an oxide;
Ba is from 97 mol to 103 mol being converted as BaO;
Re is 2 mol to 18 mol being converted as an oxide containing a metal element by one atom in one molecule; and
Me is from 2 mol to 18 mol being converted as an oxide containing a metal element by one atom in one molecule, and SiO₂ is from 0.5 mol to 10 mol.

2. A method of manufacturing dielectric ceramics comprising:
SiO₂ and a solid solution represented by:
Ba—Ti—Zr—Re-Me-O₃
where Re is at least one metal element selected from La, Ce, Pr, Nd, Sm, Eu, Gd, Tb, Dy, Ho, Er, Tm, Yb, Lu and Y, Me is a metal element selected from Mg, Cr, and Mn;
preparing TiO₂ and ZrO₂ such that Ti:Zr is from 100:0 to 75:25 by molar ratio;
preparing from 97 mol to 103 mol of a Ba compound being converted as BaO;
preparing from 2 mol to 18 mol of an Re compound being converted as an oxide containing a metal element by one atom in one molecule, and
preparing from 2 mol to 18 mol of an Me compound being converted as an oxide containing a metal element by one atom in one molecule;
based on 100 mol of TiO₂+ZrO₂; and
mixing and calcining each of the prepared compounds of Ba, Ti, Zr, Re, and Me, and then mixing SiO₂ with the calcined mixture such that it is from 0.5 mol to 10 mol based on 100 mol of Ti+Zr.

3. A multi-layer ceramic capacitor comprising:
a plurality of dielectric ceramic layers, internal electrodes formed between the dielectric ceramic layers and external electrodes connected electrically with the internal electrodes, in which the dielectric ceramic layer comprises SiO₂ and a solid solution represented by:
Ba—Ti—Zr—Re-Me-O₃
where Re is at least one metal element selected from La, Ce, Pr, Nd, Sm, Eu, Gd, Tb, Dy, Ho, Er, Tm, Yb, Lu and Y, Me is a metal element selected from Mg, Cr, and Mn;
Ti:Zr is from 100:0 to 75:25 as a molar ratio being converted as TiO₂ and being converted as ZrO₂;
Ti+Zr as 100 mol being converted as an oxide;
Ba is from 97 mol to 103 mol being converted as BaO;
Re is 2 mol to 18 mol being converted as an oxide containing a metal element by one atom in one molecule;
Me is from 2 mol to 18 mol being converted as an oxide containing a metal element by one atom in one molecule, and SiO₂ is from 0.5 mol to 10 mol; and
the internal electrode is formed of Ni or an Ni alloy.

4. A dielectric ceramic comprising:
Ti plus Zr in a mol ratio of Ti:Zr or 100:0 to 75:25, and, for every 100 mol of Ti plus Zr:
97-103 mol Ba;
2-18 mol Re;
2-18 mol Me; and
SiO₂;
wherein Re is at least one rare earth element selected from La, Ce, Pr, Nd, Sm, Eu, Gd, Tb, Dy, Ho, Er, Tm, Yb, Lu and Y and Me is at least one metal element selected from Mg, Cr, and Mn.

5. The dielectric ceramic of claim 4, wherein the dielectric ceramic comprises a perovskite structure ABO₃, wherein the A element comprises Ba, and the B element comprises Ti.

6. The dielectric ceramic of claim 5, wherein the B element further comprises Zr.
